(19) United States
(12) Patent Application Publication
(10) Pub. No.: US 2016/0070692 A1
(43) Pub. Date: Mar. 10, 2016

(54) DETERMINING SEGMENTS FOR DOCUMENTS

(71) Applicant: Microsoft Corporation, Redmond, WA (US)

(72) Inventors: Krishnaram Kenthapadi, Sunnyvale, CA (US); Anitha Kannan, Mountain View, CA (US); Sreenivas Gollapudi, Cupertino, CA (US)

(21) Appl. No.: 14/482,015

(22) Filed: Sep. 10, 2014

(51) Int. Cl. G06F 17/27

(52) U.S. Cl. CPC G06F 17/27

(57) ABSTRACT

A document is received for segmentation. The document includes multiple atomic textual units in a sequence. These units may correspond to sentences, phrases, paragraphs, concept phrases, chapters, etc. A distance function is selected that determines a distance between one set of atomic textual units and another set of atomic textual units. The distance between the sets is large for sets that are dissimilar, and small for sets that are similar. The distance function is applied to the atomic textual units to separate each of the atomic textual units into multiple segments, while maintaining the sequence of the atomic textual units.

### BACKGROUND

Text segmentation is a problem arising in applications such as information retrieval, text summarization, question answering, and discourse analysis. A goal of text segmentation is to divide a text document into a linear sequence of topically coherent segments. Instead of the entire text document, these segments can be used in applications.

In particular, information retrieval algorithms can benefit from the ability to retrieve only relevant parts of a document corresponding to a user's query instead of the entire document. For example, segmenting a newswire feed (or television close captions) into individual new stories (or television shows) may allow for easier retrieval of a relevant segment in response to a query.

### SUMMARY

A document is received for segmentation. The document includes multiple atomic textual units in a sequence. These units may correspond to sentences, phrases, paragraphs, chapters, etc. A distance function is selected that determines a distance between one set of atomic textual units and another set of atomic textual units. The distance between the sets is large for sets that are dissimilar, and small for sets that similar. The distance function is applied to the atomic textual units to separate each of the atomic textual units into multiple sequential segments, while maintaining the sequence of the atomic textual units in each segment.

In an implementation, a document is received by a computing device. The document includes atomic textual units. A distance function is received by the computing device. The distance function takes as an input a first sequential subset of the atomic textual units and a second sequential subset of the atomic textual units and outputs a distance between the first and the second sequential subsets. Segments of the document are determined using the distance function by the computing device. Each segment includes a sequential subset of the atomic textual units.

In an implementation, a document is received by a computing device. The document includes atomic textual units. A cutting function is applied that cuts the document into a first segment and a second segment by the computing device. Each segment includes a different contiguous sequence of atomic textual units of the atomic textual units. Whether the first segment and the second segment meet a stopping condition is determined by the computing device. If the stopping condition is not met, the cutting function is applied to the first segment and the cutting function is applied to the second segment by the computing device. If the stopping condition is met, the segments are output by the computing device.

In an implementation, a document is received by a computing device. The document includes atomic textual units. A distance function is received by the computing device. The distance function takes as an input a first sequential subset of the atomic textual units and a second sequential subset of the atomic textual units and outputs a distance between the first and the second sequential subsets. A first segment is generated by the computing device starting from a beginning of the document by sequentially adding atomic textual units of the document to the first segment until a determined dissonance of the first sequential segment exceeds a dissonance threshold. The dissonance of the first segment is determined using the distance function and the atomic textual units added to the first segment. A second segment is generated by the computing device starting from an end of the first segment by sequentially adding atomic textual units of the document to the second segment until a determined dissonance of the second segment exceeds the dissonance threshold. The dissonance of the second segment is determined using the distance function and the atomic textual units added to the second segment. The generated segments are associated with the document by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for segmenting documents;

FIG. 2 is an illustration of an example document;

FIG. 3 is an illustration of an implementation of an exemplary segment engine;

FIG. 4 is an operational flow of an implementation of a method for determining one or more segments for a document;

FIG. 5 is an operational flow of an implementation of a method for recursively applying a cutting function to a document to determine a plurality of segments of the document;

FIG. 6 is an operational flow of an implementation of a method for applying a cutting function to a document to determine a plurality of segments of the document; and

FIG. 7 shows an exemplary computing environment in which example embodiments and aspects may be implemented.

### DETAILED DESCRIPTION

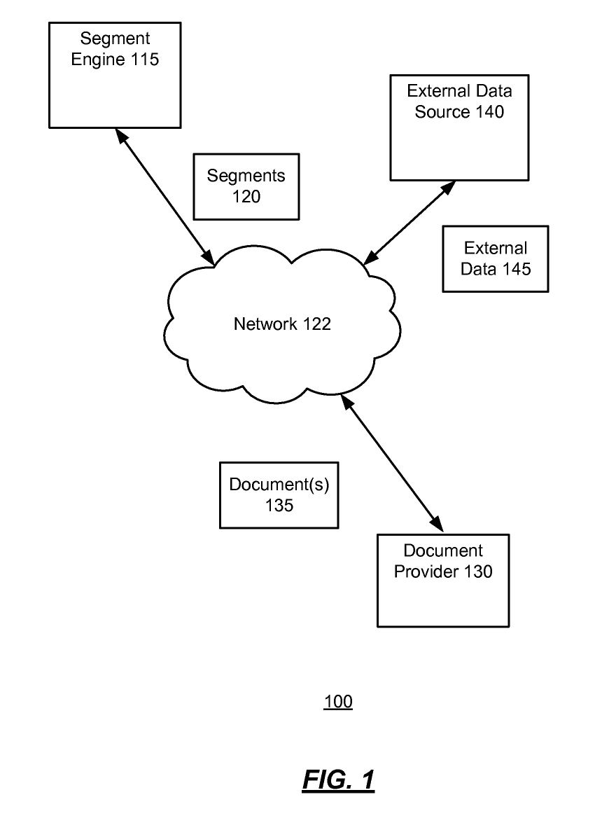

FIG. 1 is an illustration of an exemplary environment 100 for segmenting documents. The environment 100 may include a segment engine 115, an external data source 140, and a document provider 130 in communication through a network 122. The network 122 may be a variety of network types including the public switched telephone network (PSTN), a cellular telephone network, and a packet switched network (e.g., the Internet). Although only one segment engine 115, one external data source 140, and one document provider 130 are shown in FIG. 1, there is no limit to the number of segment engines 115, external data sources 140, and document providers 130 that may be supported.

The document provider 130 may provide and/or generate one or more documents 135. A document 135 may be a digital document or an electronic document and may include a variety of document types including, but not limited to books, textbooks, pamphlets, thesis papers, research papers, transcripts, dictionaries, blogs, journals, and encyclopedias, for example. Any type of document may be supported. The document(s) 135 may be stored and distributed in a variety of formats including, but not limited to, PDF, HTML, XML, e-pub, etc. Other formats may be used.

Each document 135 may comprise a plurality of atomic textual units. Depending on the implementation, the atomic textual units may be letters, words, phrases, sentences, paragraphs, or pages, for example. Any arbitrary grouping of text or characters may considered an atomic textual unit.

For a long document 135, it may be useful to divide the document 135 into multiple segments 120. Accordingly, the environment 100 may include a segment engine 115 that receives a document 135 and divides the document into multiple segments 120. Each segment 120 may include atomic textual units that are related to each other or that are directed to or associated with a common topic or subject. Alternatively, the atomic textual units in a first segment are more related to each other than the atomic textual units in an adjacent segment. The number of segments 120 that a document 135 is divided into by the segment engine 115 may be dependent on a granularity selected by a user or an administrator as well as the characteristics of the document 135 itself.

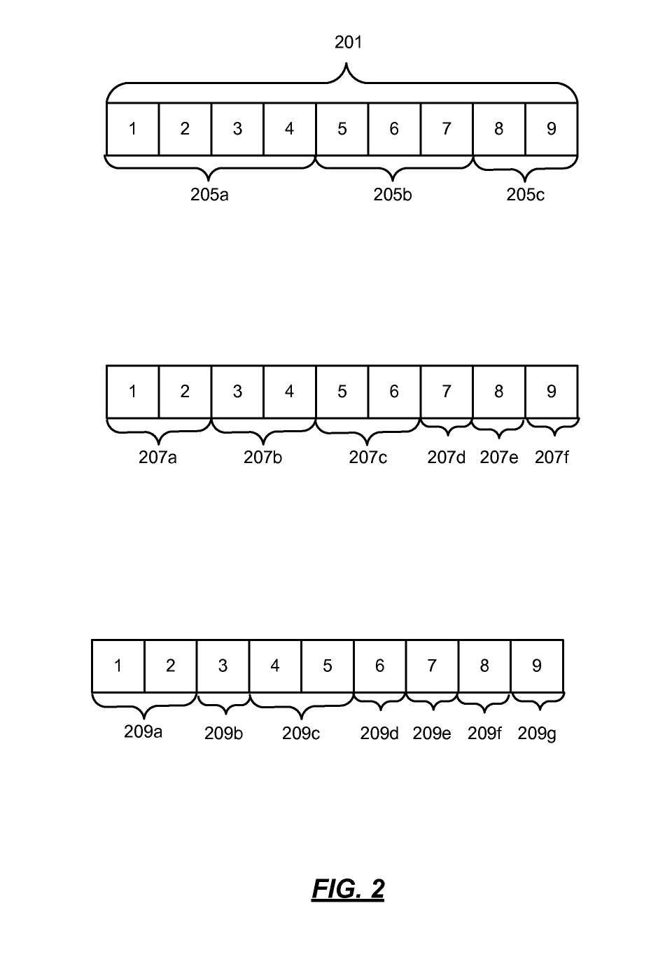

As may be appreciated, the atomic textual units of a document 135 may be viewed as a sequence with an order that is based on when the atomic textual units appear in the document 135. For example, FIG. 2 shows an example document 201 that is made up of multiple squares that represent sequential atomic textual units of the document 210. These atomic textual units are labeled 1-9 which correspond to the ordering of the atomic textual units in the document 201.

The segments 120 generated from a document 135 by the segment engine 115 may themselves be sequential and may preserve the ordering of the underlying atomic textual units of the document 135. Continuing the example shown in FIG. 2, the document 201 has been divided into the three sequential segments 205a, 205b, and 205c by the segment engine 115. As illustrated, each of the segments 205a-205c includes the atomic textual units in the same order or sequence that they appeared in the document 201.

The segment engine 115 may generate segments 120 for a document 135 using a distance function. The distance function is a function that takes as an input two atomic textual units, and outputs a distance between the two atomic textual units. A distance value of zero may indicate that the atomic textual units are the same, while a high distance value may indicate that the atomic textual values are very different. Any type of distance function may be used.

In some implementations, the distance function may use external data 145 (such as a list of related words or phrases) to determine or calculate the distance. For example, the external data 145 may be scores for multiple words and phrases based on how often they appear together or near each other in an external data source 140 such as an encyclopedia, or how often the words or phrases appear together in a website or are used together in a query. Any type of external data 145 that tends to indicate how words or phrases are related, or not related, may be used.

The distance function used by the segment engine 115 may be a continuous distance function. A continuous distance function may determine or calculate the distance between any two sets of atomic textual units. The sets of atomic textual units may be the same or of different sizes. Thus, for example, the continuous distance function may determine the distance between a set of atomic textual units with five atomic textual units and a set of atomic textual units with seven atomic textual units. Any sized set of atomic textual units may be supported. Similar to the distance function, the continuous distance function may also utilize external data 145. Any reference to a distance function herein may also refer to a continuous distance function, and vice versa.

In some implementations, the techniques, algorithms, and distance function used by the segment engine 115 to divide a document 135 into segments 120 may satisfy one or more of the following properties: hierarchical consistency, sequential consistency, and information monotonicity. More or fewer properties may be supported.

The hierarchical consistency property is that for a document 135 that is divided into a first plurality of segments 120 using an algorithm, if the document 135 is later divided into a second plurality of segments 120 that is greater than the first plurality using the same algorithm, then each of the second plurality of segments 120 will be sub-segments of the first plurality of segments.

For example, looking at FIG. 2, if the document 201 is divided into segments 120 that are smaller than the segments 205a, 205b and 205c, one example of a segmentation that satisfies the hierarchical consistency property is shown by the segments 207a, 207b, 207c, 207d, 207e, and 207f because each of the segments 207 is a sub-segments of one of the segments 205a-205c. The segments 207a and 207b are sub-segments of the segment 205a, the segments 207c and 207d are sub-segment of the segment 205b, and the segments 207e and 207f are sub-segments of the segment 205c.

In contrast, the segments 209a, 209b, 209c, 209d, 209e, 209f, and 209g violate the hierarchical consistency property. Atomic textual units 4 and 5 of the segment 209c are from both the segment 205a and 205b, and therefore the segment 209c is not a sub-segment of any of the segments 205a, 205b, or 205c.

The sequential consistency property is that when a document 135 is divided into multiple segments, if at a later time additional atomic textual units are appended to the end of the document 135, the segmentation of document 135 may not change with respect to the original atomic textual units. For example, if the document 201 is extended by adding atomic textual units 10 and 11 (not shown), when the segment engine 115 divides the document 210 into segments, the atomic textual units 1, 2, 3, and 4 may still be included in the segment 205a, the atomic textual units 5, 6, and 7 may still be included in the segment 205b, and the atomic textual units 8 and 9 may still be included in the segment 205c. The new atomic textual units 10 and 11 may be included in the segment 205c, or may be included in one or more new segments 205.

The information monotonicity property is that when more information is made available to the segment engine 115 when generating the segments 120 from a document 135 (e.g., more external data 145, or information occurring later in a document 135), the segment engine 115 may make more informed segments 120 in view of the additional information. This property may conflict with the sequential consistency property because the sequential consistency property does not change the segments 120 in view of the additional atomic textual units appended to the end of the document 135. A user or administrator may select whether or not a particular segmentation technique used by the segment engine 115 follows either of the segmentation consistency property and the information monotonicity property.

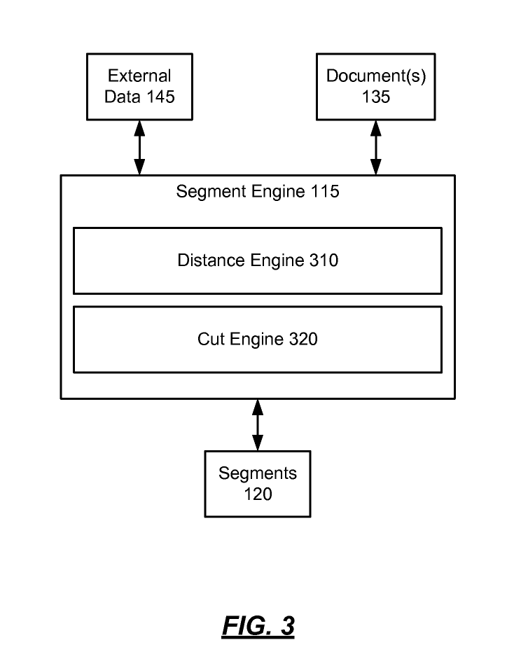

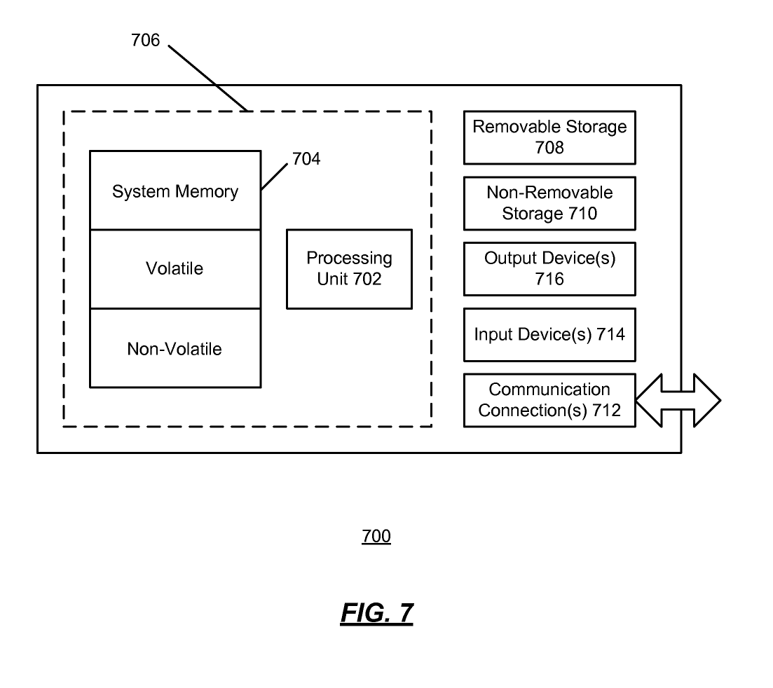

FIG. 3 is an illustration of an implementation of an exemplary segment engine 115. The segment engine 115 may include one or more components including a distance engine 310 and a cut engine 320. More or fewer components may be included in the segment engine 115. Some or all of the components of the segment engine 115 may be implemented by one or more computing devices such as the computing device 700 described with respect to FIG. 7.

The distance engine 310 may implement the distance function that is used by the segment engine 115 to determine the segments 120 for a document 135. The distance function may take an input two atomic textual units of a document 135 and may return the distance between the two atomic textual units. Alternatively, the distance function may be a continuous distance function and may take as an input two sets of atomic textual units and may output the distance between the two sets. Depending on the implementation, the distance function applied by the distance engine 310 may incorporate external data 145 that indicates the relative similarity or dissimilarity of a variety of words and phrases. Any type of distance function may be used.

In some implementation, the distance function applied by distance engine 310 for two atomic textual units p and q, may determine a set of concept phrases that are associated with the atomic textual unit p and a set of concept phrases that are associated with the atomic textual unit q. The concept phrases may be high level ideas or subjects that are associated with the atomic textual unit. The concept phrases may be determined for each atomic textual unit using external data 145 such as information from an electronic dictionary or encyclopedia. Any method for determining concept phrases for an atomic textual unit may be used.

The distance function applied by the distance engine 310 may determine the similarity of each concept phrase determined for the atomic textual unit p with respect to each concept phrase determined for the atomic textual unit q. These similarities may be determined using the closeness of the concept phrases with respect to links in an encyclopedia, or other web page, for example. Other methods for determining the similarity of concept phrases may be used.

The distance function applied by the distance engine 310 may determine the distance between the atomic textual units p and q based on a sum of all of the similarities determined for the concept phrases, and may determine the distance between the atomic textual units based on the similarities. For example, the distance may be determined based on an average similarity, an inverse of the average similarity, or by subtracting the average similarity from one. Other methods may be used.

The cut engine 320 may determine a position of the document 135 to “cut” or divide the document 135, or an already generated segment 120 of the document 135, into two segments 120. The cut engine 320 may determine the position in the document 135 by applying what is referred to herein as a cutting function. Depending on the implementation, the cutting function applied by the cut engine 320 may incorporate one or more distance functions provided by the distance engine 310.

The cutting function applied by the cut engine 320 may take as an input the document 135, or a segment 120 of the document 135, and may determine the optimal position in the document 135 or segment 120 to make a cut and divide the document 135 or segment 120 into two segments 120.

The optimal position may be the position that maximizes a quality of the cut. In some implementations, the position that maximizes a difference between the atomic textual units that proceed the cut, and the atomic textual units that follow the cut, may be the position that maximizes the quality of the cut. Other measures of quality may be used.

The cut engine 320 may recursively apply the cutting function to the document 135, and the resulting segments 120 of the document 135, until one or more stopping conditions are met. One example of a stopping condition is that the determined maximum quality for a proposed cut falls below a threshold quality. This may indicate that the particular segment 120 being considered to cut is already very cohesive and should not be further segmented. The threshold quality may be set by a user or an administrator. Each instance of the cutting function instantiated by the cut engine 320 may stop when the determined maximum quality for a proposed cut falls below a threshold quality.

Another example of a stopping condition is a quantity threshold. The quantity threshold hold may indicate a maximum number of segments 120 that are desired or selected by a user or an administrator. After the maximum number of segments 120 are generated, the cut engine 320 may stop all of the instances of the cutting function.

Another example of a stopping condition is a dissonance threshold. Dissonance is a measure of a lack of coherence of a segment 120. When the combined dissonance across all of the segments generated so far exceeds a dissonance threshold, the cut engine 320 may stop all of the instances of the cutting function.

As may be appreciated, some or all of the stopping conditions may be combined by the cut engine 320. For example, the cut engine 320 may specify both a quality threshold and a quantity threshold.

The cut engine 320 may use a variety of different functions to determine the position associated with the maximum quality cut. One example of such a function includes a conductance function. The conductance function may select a position for a cut that maximizes a ratio of the distance between the first segment 120 and the second segment 120 generated by the cut, and the greater of a volume of the first segment 120 or a volume of the second segment 120. The volume of a segment 120 may be determined based on a sum of the distances between each atomic textual unit of the segment 120. Other measures of volume may be used.

Another example of a maximum quality cut function includes a relative dissonance function. The relative dissonance function may select a position for a cut of a segment 120 that maximizes a ratio of a dissonance of the entire document 135 to the maximum of a dissonance of the resulting first segment and a dissonance of the resulting second segment. Any type of dissonance function may be used.

Another example of a maximum quality cut function is an incremental dissonance function. The incremental dissonance function may move across the document 135 (or segments 120) and may add atomic textual units to a proposed first segment. Before adding the atomic textual unit to the proposed segment, the cut engine 320 may determine what the dissonance of the proposed segment would be if the atomic textual unit were added. If the dissonance is greater than a threshold dissonance, then the atomic textual unit is used as the location for the cut.

Depending on the implementation, rather than recursively apply the cutting function to a document 135, the cut engine 320 may apply a cutting function to the atomic textual units of the document 135 in order and may generate segments 120 as the atomic textual units are processed. This type of application may be well suited for implementations where the document 135 is being streamed to the segment engine 115, or where the entire document 135 is not yet available to the segment engine 115.

In these implementations, the cut engine 320 may receive atomic textual units of the document 135 in sequential order. For each atomic textual unit, the cut engine 320 may determine if the dissonance of a current segment is increased past a threshold dissonance when the atomic textual unit is added to the current segment. If it does not, then the atomic textual unit is added to the current segment, and the next atomic textual unit is similarly processed. If it does, then the current segment is closed, and a new segment is started with the atomic textual units. Subsequently processed segments will either be added to the new segment, or used to create another new segment as described above.

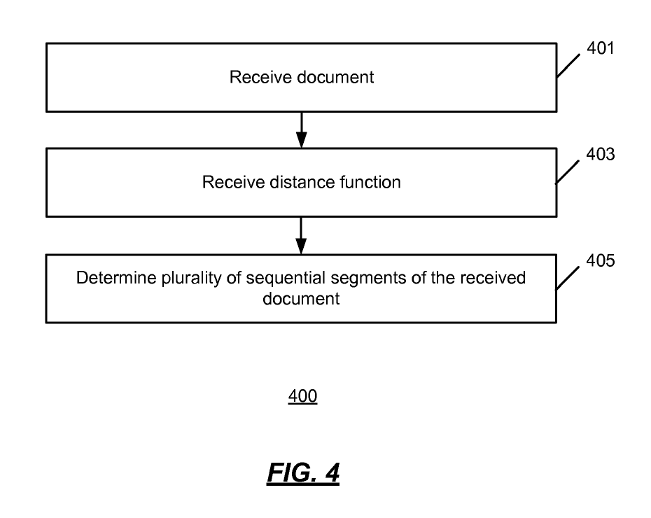

FIG. 4 is an operational flow of an implementation of a method 400 for determining one or more segments for a document 135. The method 400 may be implemented by the segment engine 115.

At 401, a document is received. The document 135 may be received by the segment engine 115 from a document provider 130. The document 135 may include a sequence of atomic textual units. The atomic textual units may be the smallest text elements of the document and may include words, phrases, sentences, or paragraphs, for example. The document 135 may be a long document and may include a variety of text documents including e-books, text books, transcripts, web pages, journal articles, etc. Any type of text document may be supported.

At 403, a distance function is received. The distance function may be received by the distance engine 310 of the segment engine 115. The distance function may be a continuous distance function and may determine a distance between a first set of atomic textual units and a second set of atomic textual units. The distance function may use external data 145 such as a listing of known related words or phrases to determine the distance. Any type of distance function may be used.

At 405, a plurality of segments is determined for the received document. The segments 120 may be determined by the cut engine 320 of the segment engine 115. The segments 120 may be sequential and each segment 120 may include a different sequential subset of the atomic textual units.

Depending on the implementation, the cut engine 320 may determine the segments using a cutting function. The cut engine 320 may apply a cutting function that cuts the document into a first segment and a second segment based on the distance function. The cut engine 320 may then recursively apply the cutting function to each of the first segment and the second segment to generate smaller segments until it is determined that a stopping condition is met. The generated segments 120 may then be output as the plurality of segments.

In another implementation, the cut engine 320 may apply the cutting function to each atomic textual unit according to the order of the atomic textual units. The cut engine 320 may start at the first atomic textual unit of the document and add it to a segment 120. The cut engine 320 may continue to add atomic textual units to the segment 120 until a dissonance of the segment 120 exceeds, or is about to exceed, a dissonance threshold. Subsequent atomic textual units in the sequence may then be added to a new segment 120.

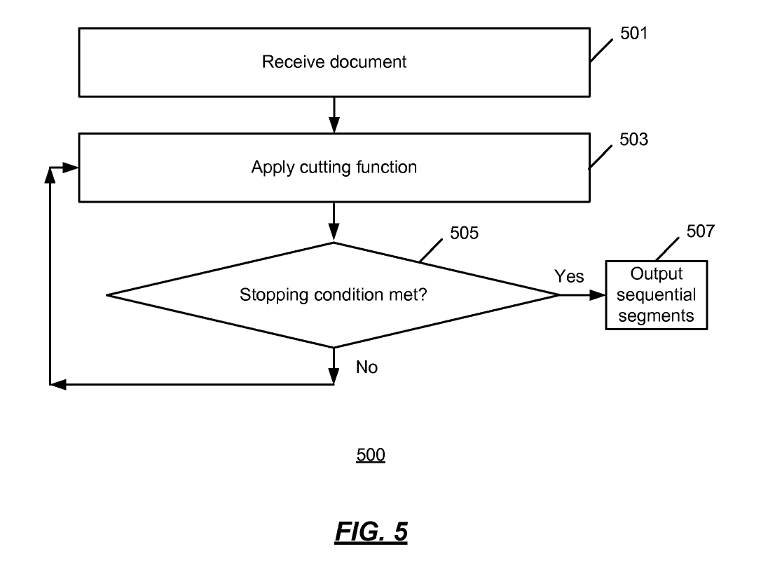

FIG. 5 is an operational flow of an implementation of a method 500 for recursively applying a cutting function to a document to determine a plurality of segments. The method 500 may be implemented by the segment engine 115.

At 501, document is received. The document may be received by the segment engine 115 from a document provider 135. The document may include a sequence of atomic textual units.

At 503, a cutting function is applied to the document. The cutting function may be applied to the document 135 by the cut engine 320 of the segment engine 115. Depending on the implementation, the cutting function may determine an atomic textual unit of the document 135 at which to cut the document 135 into two segments 120 that yields the highest quality cut. The quality of a cut may be measured using a variety of functions including a distance function (i.e., the distance between the two segments resulting from the cut), and a dissonance function (i.e., the dissonance of the two segments resulting from the cut). Other suitable functions include an incremental dissonance function, a relative dissonance function, and a conductance function.

At 505, a determination is made as to whether a stopping condition is met. Whether the stopping condition is met may be determined by the cut engine 320 of the segment engine 115. The stopping condition may cause one or all of the instances of the cutting function to stop generating segments 120. Examples of stopping conditions include one or more of a total number of generated segments 120 exceeding a threshold number, a quality of a cut falling below a threshold cut quality, or a dissonance of the sequential segments 120 exceeding a threshold dissonance. Other stopping conditions may be used. If the stopping condition is met then the method 500 may continue at 507. Otherwise, the method 500 may continue at 503, where the cutting function may be applied to each of the segments 120 generated by the cutting function at 503.

At 507, the generated segments are output. The generated segments may be output by the segment engine 115. The generated segments 120 may be all segments 120 that were generated by an instance of the cutting function. The segments 120 may further be associated with, and or distributed with, the document 135 that they were generated from.

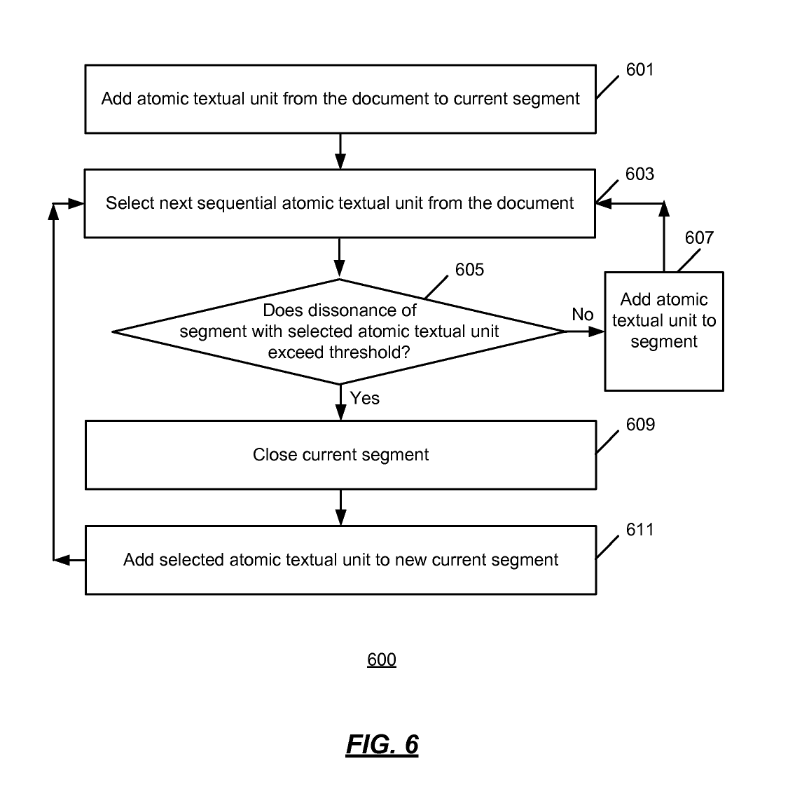

FIG. 6 is an operational flow of an implementation of a method 600 for applying a cutting function to a document to determine a plurality of segments. The method 600 may be implemented by the segment engine 115.

At 601, an atomic textual unit from a document is added to a current segment. The atomic textual unit may be a word, phrase, or sentence, and may be added to a segment 120 by the cut engine 320 of the segment engine 115. The added atomic textual unit may be the first atomic textual unit of a document 135. Depending on the implementation, the document 135 may be streamed to the cut engine 320, and each of the atomic textual units that make up the document 135 may not have been received by the cut engine 320.

A next sequential atomic textual unit is selected at 603. The next sequential atomic textual unit may be selected by the cut engine 320, and may be the atomic textual unit that immediately proceeds the atomic textual unit that was added to the segment 120 at 601 according to an ordering of the atomic textual units in the document 135.

At 605, a determination is made as to whether a dissonance of the current segment with the selected segment included exceed a threshold dissonance. The determination may be made by the cut engine 320 of the segment engine 115. Dissonance is measure of how much the atomic textual units in a segment are dissimilar. Thus, if the total dissonance of a segment rises past a threshold dissonance when the selected atomic textual unit is added to the segment 120, then the selected atomic textual unit is unlikely to be related to the other atomic textual units in the segment 120. If the dissonance is above the threshold, then the method 600 may continue at 609. Otherwise, the method 600 may continue at 607.

At 607, the selected atomic textual unit is added to the current segment. The selected atomic textual unit may be added to the current segment 120 by the cut engine 320 of the segment engine 115. After adding the selected atomic textual unit to the current segment 120, the method 600 may return to 603 where a next sequential atomic textual unit may be selected from the document 135. The selected atomic textual unit may be the atomic textual unit that immediately follows the atomic textual unit that was added to the current segment 120 at 607.

At 609, the current segment is closed. The current segment may be closed by the cut engine 320. Because the dissonance would exceed the threshold dissonance if the selected atomic textual unit were added to the segment 120, no further atomic textual units may be added to the segment 120.

At 611, the selected atomic textual unit is added to a new current segment. The selected atomic textual unit may be added to the new current segment 120 by the cut engine 320. After adding the selected atomic textual unit to the new current segment 120, the method 600 may return to 603 where a new atomic textual unit may be considered for the new current segment 120.

FIG. 7 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

In an implementation, a document is received by a computing device, wherein the document comprises a plurality of atomic textual units. A distance function is received by the computing device, wherein the distance function takes as an input a first sequential subset of the plurality of atomic textual units and a second sequential subset of the plurality of atomic textual units and outputs a distance between the first and the second sequential subsets. A plurality of segments of the document is determined using the distance function by the computing device, wherein each segment include a sequential subset of the plurality of atomic textual units.

Implementations may include some or all of the following features. Each segment may include a different subset of the plurality of atomic textual units, and each of the plurality of atomic textual units may be in only one segment. The plurality of segments may have one or more of the properties of hierarchical consistency, sequential consistency, and information monotonicity. The atomic textual units may comprise one or more of words phrases, sentences, and paragraphs. Determining a plurality of segments of the document using the distance function may include applying a cutting function that cuts the document into a first segment and a second segment at a selected atomic textual unit of the document based on the distance function, recursively applying the cutting function to each of the first segment and the second segment to generate smaller segments until it is determined that a stopping condition is met, and in response to determining that the stopping condition is met, outputting the generated smaller segments as the determined plurality of segments. The stopping condition may comprise one or more of a total number of generated smaller segments exceeding a threshold number, a quality of a cut falling below a threshold quality, or a dissonance of the smaller segments exceeding a threshold dissonance. The selected atomic textual unit may be selected using a quality of cut function. The quality of cut function may be one or more of a conductance function, a relative dissonance function, and an incremental dissonance function. Determining a plurality of segments of the document using the distance function may include generating a first segment starting from a beginning of the document by sequentially adding atomic textual units of the document to the first segment until a determined dissonance of the first segment exceeds a dissonance threshold, wherein the dissonance of the segment is determined based on the distance function, generating a second segment starting from an end of the first segment by sequentially adding atomic textual units of the document to the second segment until a determined dissonance of the second segment exceeds the dissonance threshold, and outputting the generated segments as the determined plurality of segments.

In an implementation, a document is received by a computing device, wherein the document comprises a plurality of atomic textual units. A cutting function is applied that cuts the document into a first segment and a second segment by the computing device, wherein each segment comprises a different contiguous sequence of atomic textual units of the plurality of atomic textual units. Whether the first segment and the second segment meet a stopping condition is determined by the computing device. If the stopping condition is not met, the cutting function is applied to the first segment and the cutting function is applied to the second segment by the computing device. If the stopping condition is met, the segments are output by the computing device.

Implementations may include some or all of the following features. The segments may have one or more of the properties of hierarchical consistency, sequential consistency, and information monotonicity. The atomic textual units may include one or more of words, phrases, sentences, and paragraphs. The stopping condition may include one or more of a total number of segments exceeding a threshold number, a quality of the cut falling below a threshold quality, or a dissonance of the segments exceeding a threshold dissonance. Applying a cutting function that cuts the document into a first segment and a second segment may include selecting an atomic textual unit in the document that maximizes a quality of the cut. The atomic textual unit that maximizes the quality of the cut may be selected using one or more of a conductance function, a relative dissonance function, and an incremental dissonance function. The quality of the cut may be measured based on a distance between the sequence of sequential atomic textual units associated with the first segment and the sequence of sequential atomic textual units associated with the second segment. Applying the cutting function to the first segment and applying the cutting function to the second segment may include recursively applying the cutting function to both the first segment and the second segment until the stopping condition is met.

In an implementation, a system may include a computing device and a segment engine. The segment engine may be adapted to: receive a document, wherein the document comprises a plurality of atomic textual units; receive a distance function, wherein the distance function takes as an input a first sequential subset of the plurality of atomic textual units and a second sequential subset of the plurality of atomic textual units and outputs a distance between the first and the second sequential subsets; generate a first segment starting from a beginning of the document by sequentially adding atomic textual units of the document to the first segment until a determined dissonance of the first segment exceeds a dissonance threshold, wherein the dissonance of the first segment is determined using the distance function and the atomic textual units added to the first segment; generate a second segment starting from an end of the first segment by sequentially adding atomic textual units of the document to the second segment until a determined dissonance of the second segment exceeds the dissonance threshold, wherein the dissonance of the second segment is determined using the distance function and the atomic textual units added to the second segment; and associate the generated segments with the document.

Implementations may include some or all of the following features. Receiving the document may include receiving each of the atomic textual units in a stream, and the first segment may be generated before all of the plurality of atomic textual units associated with the document have been received in the stream. The atomic textual units may include one or more of words phrases, sentences, and paragraphs.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a document comprising a plurality of atomic textual units, by a computing device;
receiving a distance function by the computing device, wherein the distance function takes as an input a first sequential subset of the plurality of atomic textual units and a second sequential subset of the plurality of atomic textual units and outputs a distance between the first and the second sequential subsets; and
determining a plurality of segments of the document using the distance function by the computing device, wherein each segment includes a sequential subset of the plurality of atomic textual units.

2. The method of claim 1, wherein each segment includes a different sequential subset of the plurality of atomic textual units, and each of the plurality of atomic textual units is in only one segment.

3. The method of claim 1, wherein the plurality of segments have one or more of the properties of hierarchical consistency, sequential consistency, and information monotonicity.

4. The method of claim 1, wherein the distance is computed based on external data that indicates a similarity or dissimilarity of a plurality of words and phrases.

5. The method of claim 1, wherein determining the plurality of segments of the document using the distance function comprises:
applying a cutting function that cuts the document into a first segment and a second segment at a selected atomic textual unit of the document based on the distance function;
recursively applying the cutting function to each of the first segment and the second segment to generate smaller segments until it is determined that a stopping condition is met; and
in response to determining that the stopping condition is met, outputting the generated smaller segments as the determined plurality of segments.

6. The method of claim 5, wherein the stopping condition comprises one or more of a total number of generated smaller segments exceeding a threshold number, a quality of a cut falling below a threshold quality, or a dissonance of the smaller segments exceeding a threshold dissonance.

7. The method of claim 5, wherein the selected atomic textual unit is selected using a quality of cut function.

8. The method of claim 7, wherein the quality of cut function is one or more of a conductance function, a relative dissonance function, and an incremental dissonance function.

9. The method of claim 1, wherein determining the plurality of segments of the document using the distance function comprises:
generating a first segment starting from a beginning of the document by sequentially adding atomic textual units of the document to the first segment until a determined dissonance of the first segment exceeds a dissonance threshold, wherein the dissonance of the segment is determined based on the distance function; and
generating a second segment starting from an end of the first segment by sequentially adding atomic textual units of the document to the second segment until a determined dissonance of the second segment exceeds the dissonance threshold; and
outputting the generated segments as the determined plurality of segments.

10. A method comprising:
receiving a document by a computing device, wherein the document comprises a plurality of atomic textual units;
applying a cutting function that cuts the document into a first segment and a second segment by the computing device, wherein each segment comprises a different contiguous sequence of atomic textual units of the plurality of atomic textual units;
determining if the first segment and the second segment meet a stopping condition by the computing device;
when the stopping condition is not met, applying the cutting function to the first segment and applying the cutting function to the second segment by the computing device; and
when the stopping condition is met, outputting the segments by the computing device.

11. The method of claim 10, wherein the segments have one or more of the properties of hierarchical consistency, sequential consistency, and information monotonicity.

12. The method of claim 10, wherein the atomic textual units comprise one or more of words, phrases, sentences, and paragraphs.

13. The method of claim 10, wherein the stopping condition comprises one or more of a total number of segments exceeding a threshold number, a quality of the cut falling below a threshold quality, or a dissonance of the segments exceeding a threshold dissonance.

14. The method of claim 13, wherein the quality of the cut is measured based on a distance between the sequence of sequential atomic textual units associated with the first segment and the sequence of sequential atomic textual units associated with the second segment.

15. The method of claim 10, wherein applying a cutting function that cuts the document into a first segment and a second segment comprises selecting an atomic textual unit in the document that maximizes a quality of the cut.

16. The method of claim 15, wherein the atomic textual unit that maximizes the quality of the cut is selected using one or more of a conductance function, a relative dissonance function, and an incremental dissonance function.

17. The method of claim 10, wherein applying the cutting function to the first segment and applying the cutting function to the second segment comprises recursively applying the cutting function to both the first segment and the second segment until the stopping condition is met.

18. A system comprising:
a computing device; and
a segment engine adapted to:
receive a document comprising a plurality of atomic textual units;
receive a distance function, wherein the distance function takes as an input a first sequential subset of the plurality of atomic textual units and a second sequential subset of the plurality of atomic textual units and outputs a distance between the first and the second sequential subsets;
generate a first segment starting from a beginning of the document by sequentially adding atomic textual units of the document to the first segment until a determined dissonance of the first segment exceeds a dissonance threshold, wherein the dissonance of the first segment is determined using the distance function and the atomic textual units added to the first segment;
generate a second segment starting from an end of the first segment by sequentially adding atomic textual units of the document to the second segment until a determined dissonance of the second segment exceeds the dissonance threshold, wherein the dissonance of the second segment is determined using the distance function and the atomic textual units added to the second segment; and
associate the generated segments with the document.

19. The system of claim 18, wherein receiving the document comprises receiving each of the atomic textual units in a stream, and the first segment and the second segment are generated before all of the plurality of atomic textual units associated with the document have been received in the stream.

20. The system of claim 18, wherein the atomic textual units comprise one or more of words, phrases, sentences, and paragraphs.
